(19) United States
(12) Patent Application Publication
(10) Pub. No.: US 2025/0338879 A1
(43) Pub. Date: Nov. 6, 2025

(54) MEATLESS BURGER FOOD PRODUCT

(71) Applicant: Willie Lee Smith, SR., Orlando, FL (US)

(72) Inventor: Willie Lee Smith, SR., Orlando, FL (US)

(21) Appl. No.: 18/655,404

(22) Filed: May 6, 2024

(51) Int. Cl. A23L 7/10; A23L 5/10; A23L 29/212

(52) U.S. Cl. CPC A23L 7/101; A23L 5/12; A23L 29/212

(57) ABSTRACT

A composition of materials provides a culinary masterpiece in the form of a meatless burger. The composition of ingredients of the meatless burger can provide a delicious and sustainable alternative to traditional meat-based burgers. A formula developed with offers a patty or ground “meat” for use in various dishes. The meatless burger can be shaped and cooked, providing a flavorful and satisfying vegetarian or vegan-friendly option.

### FIELD

The present disclosure generally relates to a food preparation method and product, and particularly relates to a meatless burger formula featuring ingredients such as grains, seasonings, and bases.

### BACKGROUND

In the midst of a global shift towards sustainable living and conscious consumerism, the demand for environmentally friendly dietary alternatives has increased. There is a growing need for innovative solutions as a response to the detrimental impact of conventional meat production on both health and the planet.

### SUMMARY

The following summary presents a simplified summary of certain features. The summary is not an extensive overview and is not intended to identify key or critical elements.

In accordance with the teachings of the present disclosure, the meatless burger formula is a composition of plant-based ingredients made to mimic the texture and flavor of traditional meat patties. The formula offers a sustainable alternative for individuals adhering to vegetarian, vegan, or environmentally conscious dietary preferences by leveraging innovative ingredient substitutions.

An aspect of the present disclosure provides a composition developed using ingredients such as grains, seasonings, and bases to produce a meatless “meat”. This formula's appeal extends beyond burger patties and into various dishes such as spaghetti and tacos.

An aspect of the present disclosure provides a mixture of cooked barley, onion powder, refried pinto beans, vegetable stock, olive oil, almond flour, tapioca, salt, black pepper, and minced garlic. This formula offers a flavorful and nutritious alternative to meat-based products.

Another aspect of the present disclosure is that the meatless burger formula presents a health-conscious option for individuals seeing reduced-calorie or plant-based dietary alternatives, which aligns with evolving customer preferences towards sustainable eating habits.

Another aspect of the present disclosure is that the preparation method for this meatless formula emphasizes simplicity and accessibility by guiding users through steps such as shaping the mixture into burger patties and cooking until golden brown and heated through.

An aspect of the present disclosure provides a culinary innovation that caters to the diverse needs of modern consumers by offering a delicious and sustainable alternative to traditional meat patties in various meals.

The present disclosure provides for plant-based ingredients to create a flavorful and nutritious alternative. The formula offers a versatile culinary solution by replacing ground beef, turkey, and chicken with a carefully curated blend of plant-based substitutes. The present disclosure goes beyond merely mimicking the taste and texture of meat; it presents a sustainable option that reduces reliance on animal agriculture. This innovative approach not only addresses dietary preferences, but also aligns with broader efforts to lower environmental degradation. Furthermore, the adaptability of this formula allows for its incorporation into various dishes beyond burgers, which strengthens its appeal and practicality. As society becomes increasingly aware of the connection between food choices and environmental sustainability, the significance of this innovation becomes more apparent.

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

FIG. 1 depicts the layout of ingredients required for the meatless burger formula,

FIG. 2 provides the percentages for each ingredient according to aspects of the present disclosure.

FIG. 3 illustrates barley being cooked in a pot until tender and chewy, which is a step in the formula's preparation process according to aspects of the present disclosure.

In FIG. 4, a top-down view shows the assembly of the dry ingredients in a mixing bowl: almond flour, black pepper, onion powder, and salt according to aspects of the present disclosure.

FIG. 5 is a graphical representation demonstrating the proper mixing techniques for combining all the dry ingredients together according to aspects of the present disclosure.

FIG. 6 shows the homogeneous mixture after all the dry ingredients are thoroughly combined in the mixing vessel according to aspects of the present disclosure.

FIG. 7 then shifts focus to the addition of wet ingredients to the bowl, including cooked barley, refried pinto beans, vegetable stock, olive oil, and minced garlic according to aspects of the present disclosure.

FIG. 8 shows the wet ingredients into the dry mixture to ensure an even distribution of flavors and textures according to aspects of the present disclosure.

FIG. 9 shows the top view of the mixture and displays all the ingredients fully mixed in the vessel according to aspects of the present disclosure.

FIG. 10 shows the shaping of the mixture into round spheres preparing them for further cooking according to aspects of the present disclosure.

FIG. 11 shows the spheres placed onto a baking sheet, ready to be placed in the oven for baking the patties, according to aspects of the present disclosure.

FIG. 12 is a front view of an oven set to 350-375 degrees Fahrenheit with a 20-25 minute cooking time, indicating the optimal baking conditions for the patties according to aspects of the present disclosure.

FIG. 13 illustrates the spheres placed onto a skillet with a recommended cooking time of 4-5 minutes per side for cooking the patties in the skillet, according to aspects of the present disclosure.

FIG. 14 showcases the top view of the burgers after cooking in the skillet/oven, displaying their golden-brown exterior and ensuring they are heated through according to aspects of the present disclosure.

### DETAILED DESCRIPTION

The features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings

The present specification as well as various commercial and consumer products may provide an alternative to the seasonings by providing additional seasoning options for the user. The mixture itself may comprise a combination of cooked barley, almond flour (or other vegan flour), refried pinto beans, olive oil, seasonings, and minced garlic that is hand molded into the desired shape.

As used herein, a CAS Registry Number (also referred to CAS Number) is a unique identification number assigned by the Chemical Abstracts Service (CAS), US to chemical substance described in the open scientific literature. CAS Registry Numbers can be convenient for database searches. They offer a reliable, common and international link to every specific substance across the various nomenclatures and disciplines used by branches of science, industry, and regulatory bodies. Almost all molecule databases today allow searching by CAS Registry Number.

Terms of degree such as “generally”, “substantially”, “about” and “approximately” as used herein mean a reasonable amount of deviation of the modified term such that the end result is not significantly changed. For example, these terms can be construed as including a deviation of at least+−0.5% of the modified term if this deviation would not negate the meaning of the word it modifies.

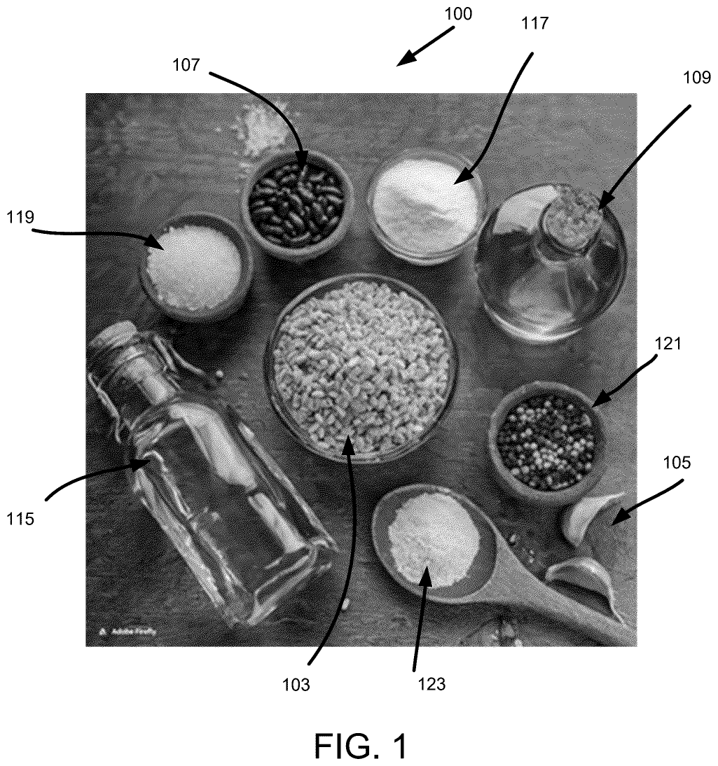

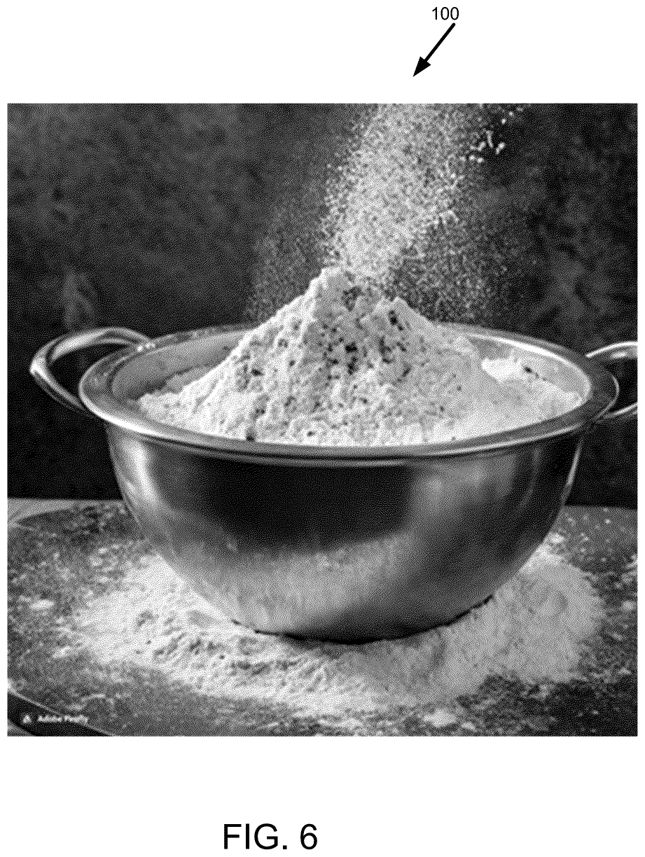

The following example will illustrate a method of preparing the meatless food product 100 mixture in accordance with the present disclosure FIGS. 1-14. As an example of the use of these materials, a meatless burger 600 in a solid formulation. The formula is particularly suitable for vegetarian or vegan diets may be made as follows. In accordance with the teachings of the present disclosure, the mixture of the ingredients may be formed to create burger patties 600 or a ground meatless-product to replace grounded animal meat. An aspect of the present disclosure is to provide the method for mixing, forming, and cooking the ingredients to create the burger patties or ground meatless-substitute of animal meat.

As used herein, the meatless burger formula comprises a combination of ingredients selected to mimic a texture and flavor of traditional meat-based burgers while offering a vegetarian or vegan-friendly alternative. The present disclosure goes beyond merely mimicking the taste and texture of meat; it presents a sustainable option that reduces reliance on animal agriculture. This innovative approach not only addresses dietary preferences, but also aligns with broader efforts to lower environmental degradation. Furthermore, the adaptability of this formula allows for its incorporation into various dishes beyond burgers, which strengthens its appeal and practicality. As society becomes increasingly aware of the connection between food choices and environmental sustainability, the significance of this innovation becomes more apparent.

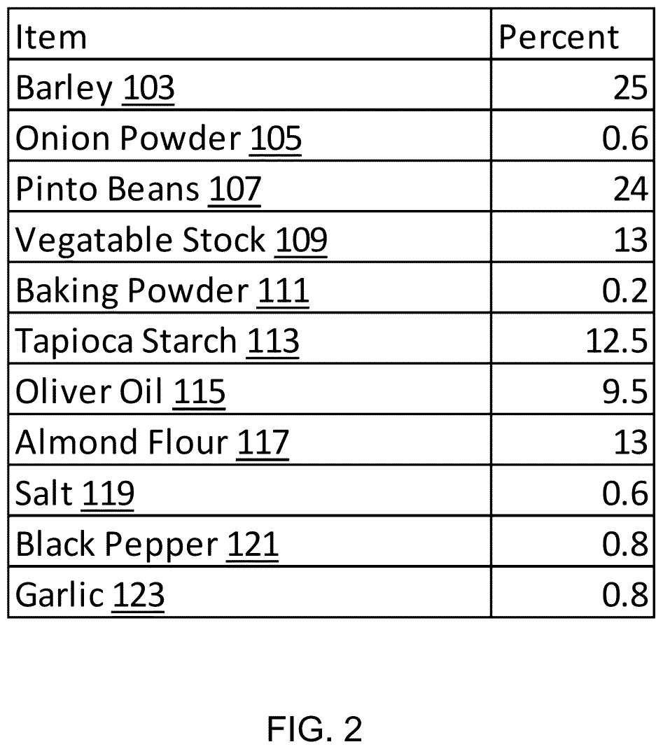

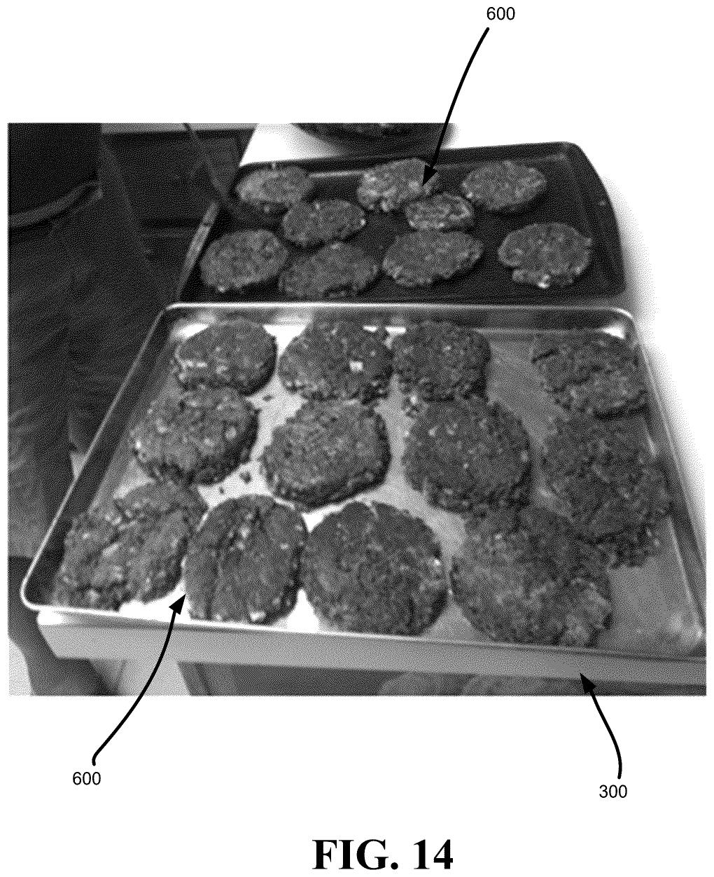

FIG. 1 depicts the layout of ingredients for the meatless burger formula, while FIG. 2 provides the percentages for each ingredient, ensuring measurements for ideal flavor and texture. In accordance with teachings of the present disclosure, a meatless food product composition 100 mixture makes about 20-26 disk shaped meatless patties 600 (See FIG. 14), includes about 32 oz. of barley 103, about 1.50 tablespoons of onion powder 105, about 30.4 oz of refried pinto beans 107, about 2 cups of liquid vegetable stock 109, about 1.50 teaspoons of baking power 111, about 2 cups of tapioca starch 113, about 1.50 cups of olive oil 115 (CAS No. 8001-25-0), about 1 pound of almond flour 117, about 1.50 tablespoons of salt 119, about 2 tablespoons of black pepper 121, and about 2 tablespoons of minced garlic 123.

Referring to FIG. 2, in accordance with teachings of the present disclosure, the composition 100 mixture may include about 25.0 percent by volume of cooked barley, essentially about 24.0 percent by volume of refried pinto beans, essentially about 9.5 percent by volume of olive oil (CAS No. 8001-25-0), essentially about 13.0 percent by volume of almond flour, essentially about 13.0 percent by volume of vegetable stock, essentially about 0.80 percent by volume of minced garlic, essentially about 0.60 percent by volume of onion powder, essentially about 12.5 percent tapioca starch, essentially about 0.60 percent by volume of salt (CAS No. 7647-14-5), about 0.20 percent by volume of baking power, and essentially about 0.80 percent by volume of black pepper, including, optionally, sunflower oil (CAS No. 8001-21-6).

In one formulation, the meatless burger formula includes cooked barley for texture, onion powder for flavor enhancement, refried pinto beans for protein and binding, vegetable stock for moisture, olive oil for richness, almond flour for binding and texture, salt for seasoning, black pepper for seasoning, and minced garlic for additional flavor enhancement.

The meatless burger food product 100 mixture has the structural integrity of a flexible solid and therefore can retain most of its shape and can be molded into other shapes.

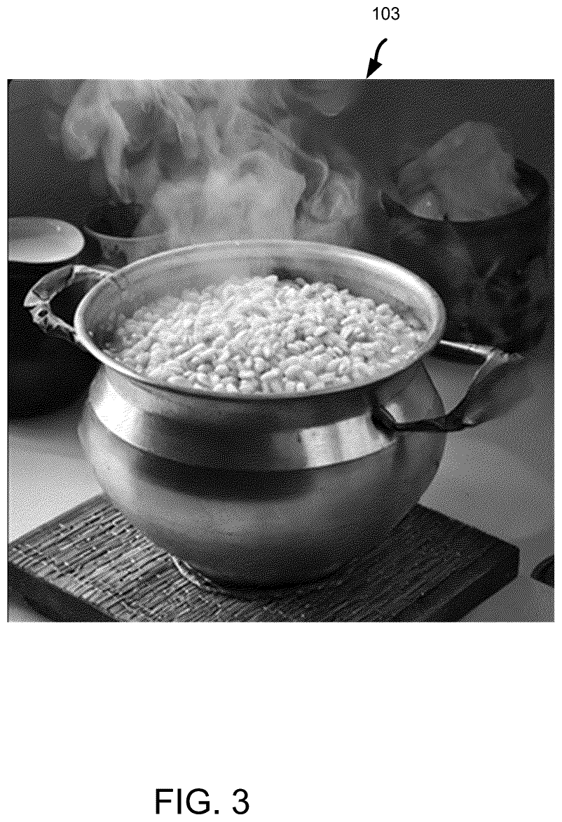

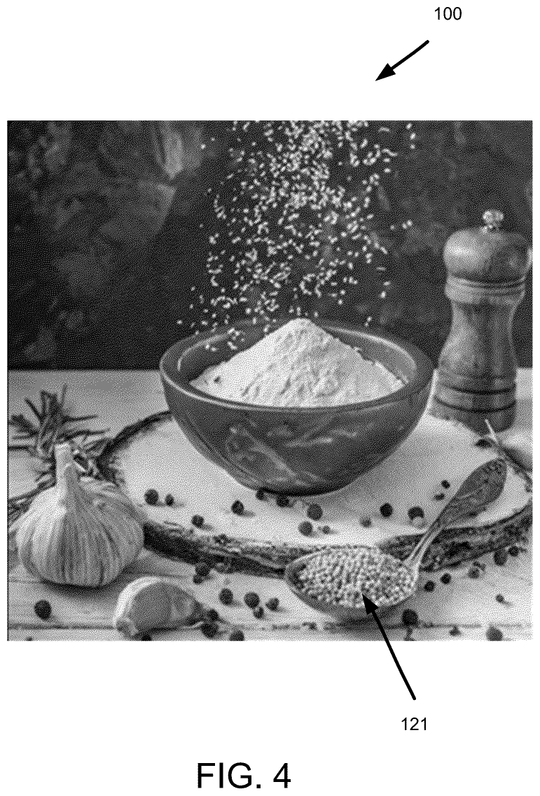

The following example will illustrate a method of preparing the mixture in accordance with the present disclosure. Cooked barley 103, comprising 25% of the formula, serves as an ingredient for providing texture to the burger patties 600 by contributing to their chewy and satisfied texture. Barley is a healthy grain that is rich in vitamins, minerals, and other beneficial plant compounds. Barley also reduces hunger and may help the consumer lose weight. Barley has high fiber contents, may help lower cholesterol, and may reduce the risk of heart disease. The magnesium and soluble fibers in barley may protect against diabetes and lower the risk of colon cancer. FIG. 3 illustrates the process of cooking barley until tender and chewy and achieving a desired texture.

Onion powder 105, constituting approximately 0.60% of the formula, adds to the flavor profile of the meatless burger, which will enhance its savory appeal. This ingredient is carefully measured and added to the dry mixture, as demonstrated in FIG. 4.

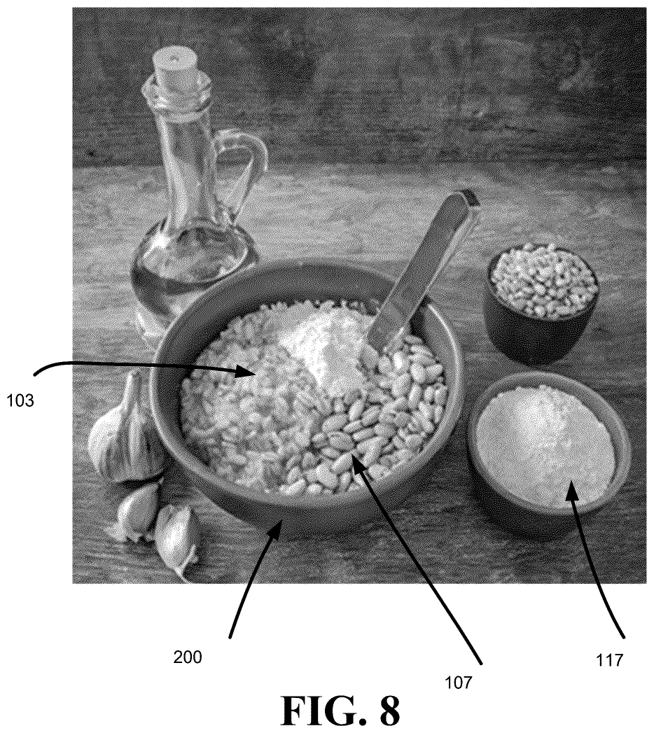

Vegetable stock 109, comprising approximately 12.6% of the formula, adds moisture to the mixture, preventing the burgers from becoming dry and instead, leaves a rich, savory taste. This liquid ingredient is combined with other wet ingredients, as demonstrated in FIG. 8, to ensure even distribution throughout the mixture.

Olive oil 115 (CAS No. 8001-25-0), making up approximately 9.50% of the formula, contributes to the richness and texture of the burger by enhancing its overall flavor profile. The process of incorporating olive oil into the mixture is depicted in FIG. 8, which emphasizes the importance of measuring and evenly distributing this ingredient.

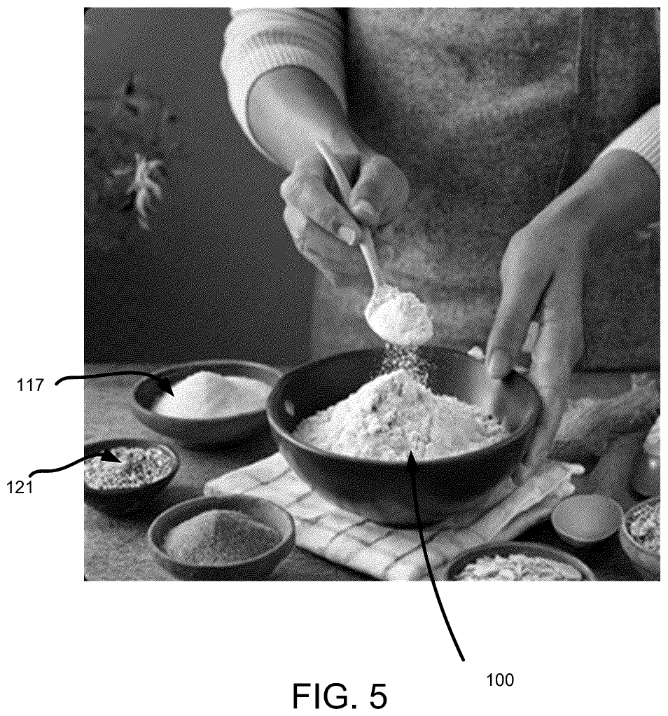

Almond flour 117, constituting approximately 12.6% of the formula, serves as a binding agent and contributes to the texture of the patties 600, ensuring they hold together well during cooking. The process of adding almond flour to the dry mixture is shown in FIG. 5, which provides for mixing techniques to achieve a homogeneous consistency.

Salt 119 and black pepper 121, each comprising approximately 0.60-0.80% of the formula, provides essential seasoning by balancing the flavors and improving the overall taste of the meatless burger. These seasonings are carefully measured and added to the dry mixture as demonstrated in FIG. 4.

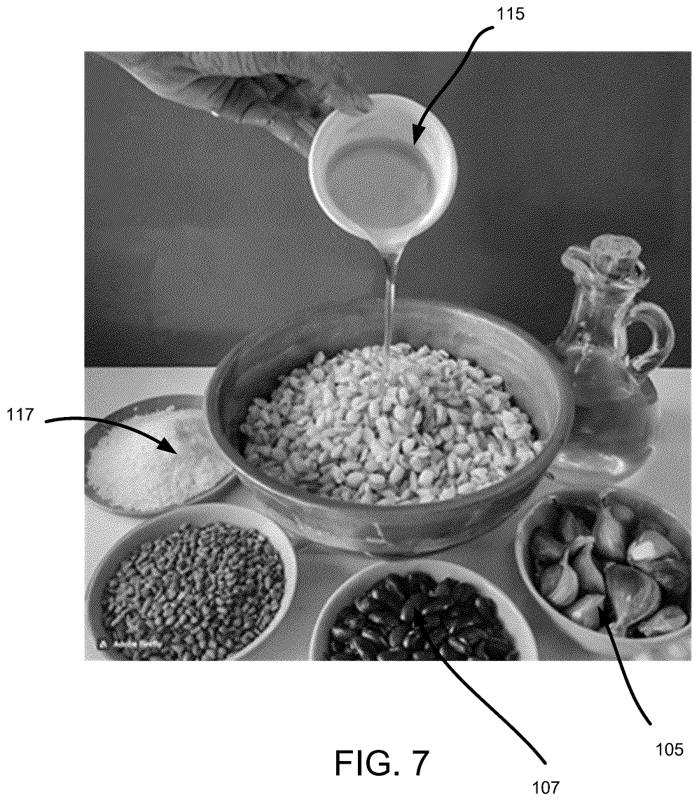

Minced garlic 123, making up approximately 0.80% of the formula, adds to the flavor profile by elevating the taste of the burgers to a new level. This flavorful ingredient is carefully incorporated into the wet mixture, as shown in FIG. 7, ensuring its general even distribution throughout the patties. Tapioca starch is extracted from the tubers of the cassava plant, a species native to the North and Northeast regions of Brazil. Tapioca starch 113 provides a binding agent for the composition food product 100 and a moisture retention agent to keep the patties 600 moist after cooking. FIG. 8 shows the wet ingredients into the dry mixture into a bowl 200 to ensure an even distribution of flavors and textures according to aspects of the present disclosure.

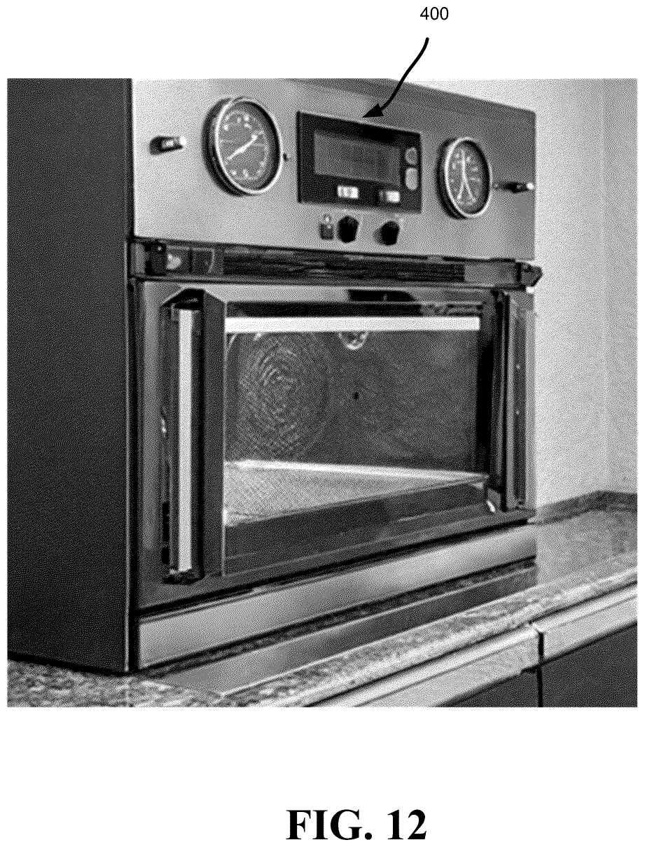

In one method, baking the burger patties 600 in an oven 400 at 350-375° F. (190° C.) for 10-12 minutes per side until golden brown and heated through, offering flexibility in cooking methods to suit individual preferences (see FIG. 12).

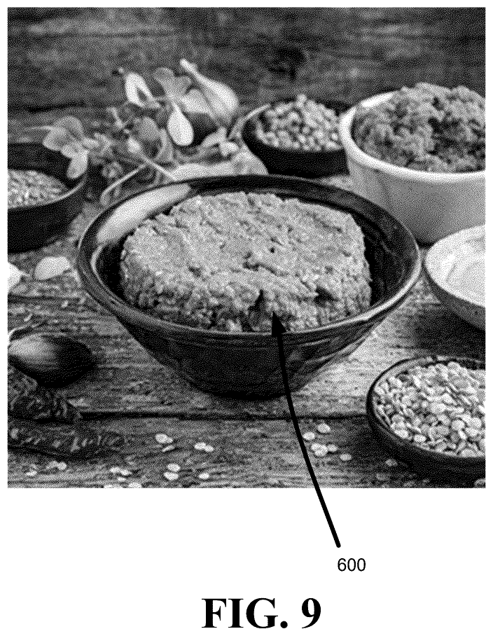

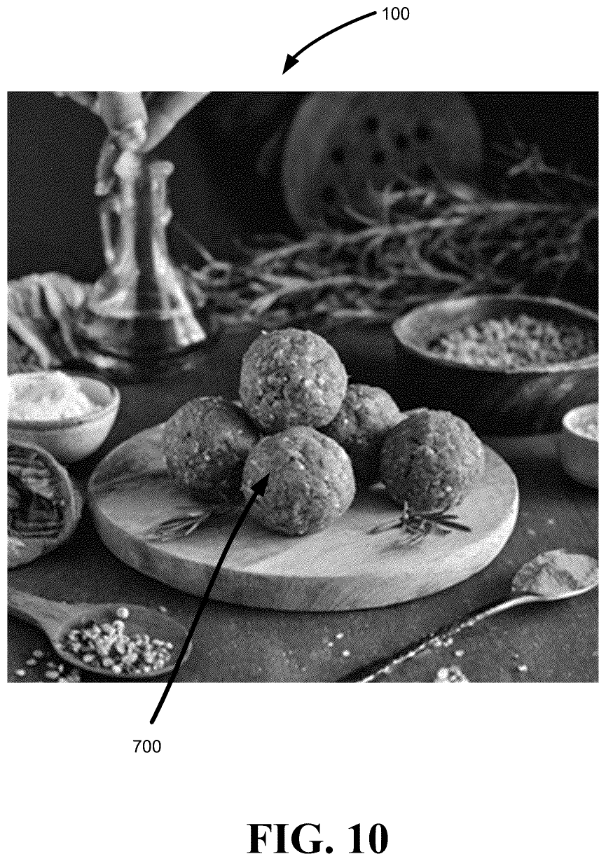

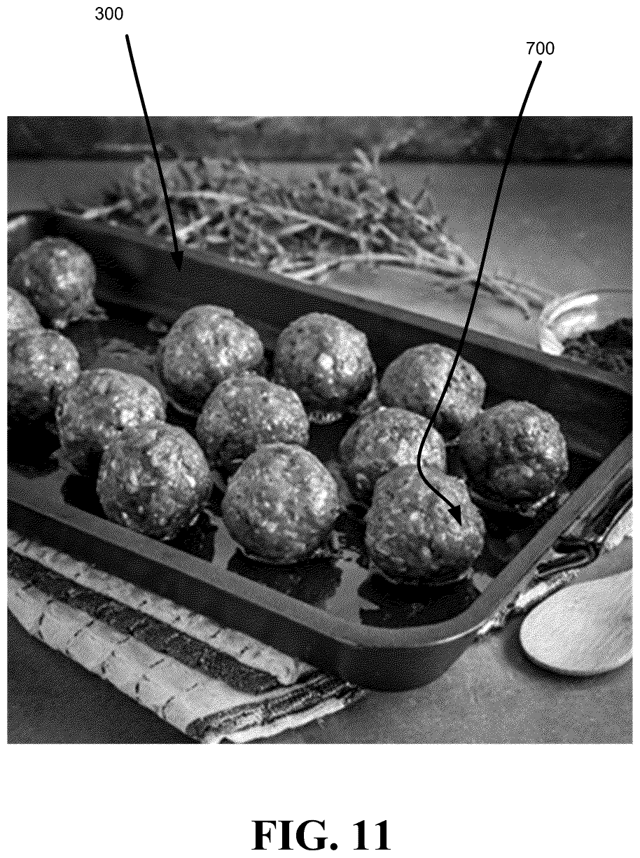

Referring to FIGS. 9-11, a method for preparing the meatless burger food product comprises combining the ingredients, shaping the mixture into burger patties 600 of disk shape or round puck size of 0.75 inches thick with a diameter between 3.0 inches to 4.0 inches, or the desired shape, cooking the patties until golden brown and heated through to 165F internal temperature, and serving in the desired way. FIG. 9 shows the top view of the mixture and displays all the ingredients fully mixed in the vessel. FIG. 10 shows the shaping of the mixture into round spheres 700, measuring about two to three inches to in diameter. FIG. 11 shows the spheres 700 placed onto a baking sheet 300, ready to be placed in the oven for baking the patties, according to aspects of the present disclosure.

The meatless burger food product 100 is adaptable for use as a substitute for meat in various dishes such as spaghetti and tacos, offers versatility in culinary applications. For example, the spheres 700 can be used to substitute for pork/beef meatballs. Also, the meatless burger food product 100 provides a health-conscious alternative to traditional meat-based products, suitable for individuals seeking reduced-calorie or plant-based dietary options to form a meatless product to replace grounded beef. The meatless burger food product 100 may include a method to a package the ingredients together by hand to form individual disc shaped burger patties 600, approximately 3.0 inches in diameter. In the method of preparation, first mix the dry ingredients before incorporating the liquids into the mixture to ensure uniform distribution. Further, the meatless burger food product formula 100 to hand mix all the ingredients together to achieve a homogeneous mixture for forming burger patties 600.

Further included in the present disclosure is a method for preparing the meatless burger food product 100 including the steps of cooking barley until tender; combining cooked barley, onion powder, refried pinto beans, vegetable stock, olive oil, almond flour, salt, black pepper, and minced garlic; shaping the mixture into burger patties; cooking the patties 600 until golden brown and heated through in an oven 400; serving on buns with desired toppings.

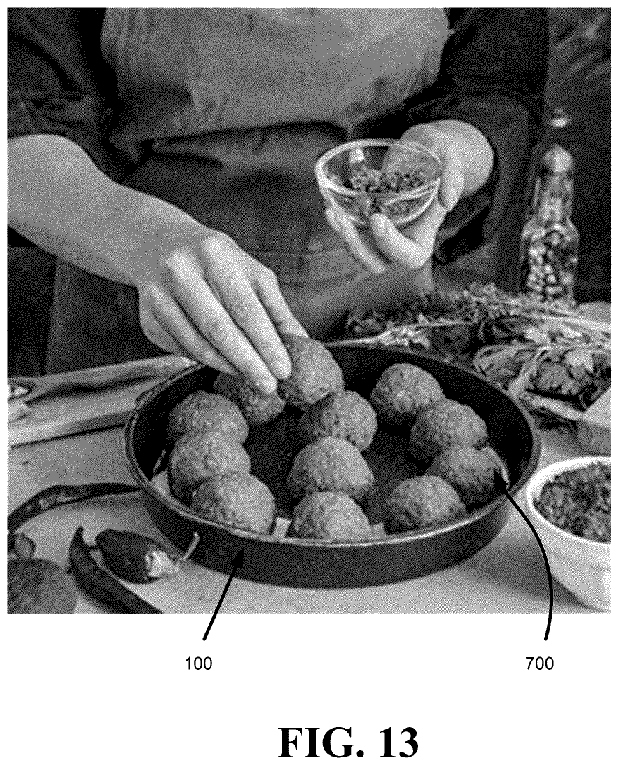

In an alternative cooking method, the patties 600 can be grilled over medium heat for 5-7 minutes per side or until desired doneness. In an alternative cooking method, referring to FIG. 13, frying the burger patties 600 in a skillet 500 with oil over medium-high heat for 4-5 minutes per side until golden brown is possible. In a further aspect, the meatless food product 100 mixture, prior to being cooked, may be packaged in 15.0 to 16.0 oz cans for retail sale and distribution.

Although the compositions and methods of the present specification as well as various commercial and consumer products containing/comprising the same have been described with respect to specific embodiments and examples, it should be appreciated that the present teachings are not limited thereto and other embodiments utilizing the concepts expressed herein are intended and contemplated without departing from the scope of the present teaching as intended in the true spirit and scope of the invention. It is therefore intended any and all modifications, variations, or equivalents that fall within the spirit and scope of the underlying principles are within the scope of this present disclosure and are covered by the appended claims.

It should be noted that the terms “including” and “comprising” should be interpreted as meaning “including, but not limited to”.

In this specification, “a” and “an” and similar phrases are to be interpreted as “at least one” and “one or more.” References to “the,” “said,” and similar phrases should be interpreted as “the at least one”, “said at least one”, etc. References to “an” embodiment in this disclosure are not necessarily to the same embodiment.

It is the applicant's intent that only claims that include the express language “means for” or “step for” be interpreted under 35 U.S.C. 112. Claims that do not expressly include the phrase “means for” or “step for” are not to be interpreted under 35 U.S.C. 112.

What is claimed is:

1. A meatless food product, comprising:
a. Cooked barley about 25.0% by volume;
b. Onion powder about 0.60% by volume;
c. Refried pinto beans about 24.0% by volume;
d. Vegetable stock about 13.0% by volume;
e. Olive oil about 9.50% by volume;
f. Almond flour about 13.0% by volume;
g. Salt about 0.60% by volume;
h. Black pepper about 0.60% by volume;
i. Minced garlic about 0.80% by volume; and
j. Tapioca starch about 12.5% by volume.

2. The meatless food product of claim 1, being adaptable for use as a substitute for meat in taco applications.

3. The meatless food product of claim 1, being adaptable for individuals to consuming a plant-based dietary food.

4. The meatless food product of claim 1, wherein said ingredients a.-j. being mixed together to form individual disk-shaped patties, approximately 3.0-4.0 inches in diameter.

5. The meatless food product of claim 1, wherein said ingredients a.-j. being mixed together to form individual spheres, approximately 3.0-4.0 inches in diameter.

6. The meatless food product of claim 1, wherein said ingredients a.-j. being mixed together to form a grounded meatless substitute.

7. The meatless food product of claim 1, wherein said ingredients a.-j. being mixed together to form a meatless product to replace grounded animal meat.

8. A method for preparing a meatless food product, comprising the steps of:
providing a food product including:
a. Cooked barley about 25.0% by volume;
b. Onion powder about 0.60% by volume;
c. Refried pinto beans about 24.0% by volume;
d. Vegetable stock about 13.0% by volume;
e. Olive oil about 9.50% by volume;
f. Almond flour about 13.0% by volume;
g. Salt about 0.60% by volume;
h. Black pepper about 0.60% by volume;
i. Minced garlic about 0.80% by volume; and
j. Tapioca starch about 12.5% by volume;
Cooking barley until tender;
Combining cooked barley, onion powder, refried pinto beans, vegetable stock, olive oil, almond flour, salt, black pepper, and minced garlic;
Shaping the mixture into puck shaped burger patties;
Cooking the patties until golden brown and heated through a thickness of the said patties.

9. The method of claim 7, further comprising grilling the burger patties over medium heat for 5-7 minutes per side.

10. The method of claim 7, further comprising frying the burger patties in a skillet with oil over medium-high heat for 4-5 minutes per side until golden brown.

11. The method of claim 7, further comprising baking the burger patties in a preheated oven at 375° F. (190° C.) for 10 to 12 minutes per side thereof.
